(19) United States
(12) Patent Application Publication
(10) Pub. No.: US 2025/0374547 A1
(43) Pub. Date: Dec. 4, 2025

(54) INTEGRATED CIRCUIT, VERIFICATION SYSTEM INCLUDING THE SAME, AND OPERATING METHOD OF THE VERIFICATION SYSTEM

(71) Applicant: Samsung Electronics Co., Ltd., Suwon-si (KR)

(72) Inventors: Changhyun JOO, Suwon-si (KR); Insang CHO, Suwon-si (KR); Wookghee HAHN, Suwon-si (KR)

(73) Assignee: Samsung Electronics Co., Ltd., Suwon-si (KR)

(21) Appl. No.: 18/944,976

(22) Filed: Nov. 12, 2024

(30) Foreign Application Priority Data
May 29, 2024 (KR) 10-2024-0070354

(51) Int. Cl. H10B 43/40; H10B 41/35; H10B 41/41; H10B 43/35

(52) U.S. Cl. CPC H10B 43/40; H10B 41/35; H10B 41/41; H10B 43/35

(57) ABSTRACT

A verification system for verifying a cell area of a flash memory model includes memory including a memory area, wherein, in order to verify the cell area, the cell area is modeled as the memory area, and an integrated circuit configured to perform a verification operation on the memory based on a verification signal for the flash memory model, wherein the integrated circuit includes a memory control logic configured to map the cell area of the flash memory model to the memory area of the memory based on the verification signal and to perform a memory operation corresponding to the verification signal to read verification data associated with the verification operation from the memory.

### CROSS-REFERENCE TO RELATED APPLICATION

This application is based on and claims priority under 35 U.S.C. § 119 to Korean Patent Application No. 10-2024-0070354, filed on May 29, 2024, in the Korean Intellectual Property Office, the disclosure of which is incorporated by reference herein in its entirety.

### BACKGROUND

Various example embodiments relate, in general, to a verification system such as a formal verification system, and more particularly, to an integrated circuit for verifying memory, a verification system including the integrated circuit, and/or an operating method of the verification system.

Memory may include at least one cell and may store data by using a method of storing electric charges in the cell. Depending on the amount of electric charges stored in the cell, the cell may be represented as a logical 0 bit or a 1 bit. Many cells are connected to each other to form flash memory read/write and erase units, such as pages and blocks. In some example memory, several chips are connected together to form multiple channels and ways.

Before actual memory is mass produced, semiconductor design verification may be performed to verify the memory. For example, it is possible to verify whether cells in the memory are expected to operate normally. The semiconductor design verification may be performed by software-simulation of the memory to be verified, and thus, the characteristics of the memory may be analyzed without using the actual memory. When verifying memory cells through software-simulation on a computer, the verification speed may decrease. Accordingly, the speed of the entire memory design processes may also decrease.

Therefore, a method of increasing the verification speed when verifying memory cells is required or desired.

### SUMMARY

Provided are an integrated circuit for verifying a cell area of a memory model, a verification system including the integrated circuit, and/or an operating method of the verification system. Alternatively or additionally, provided is a verification system capable of increasing verification speed, wherein the verification system simulates a memory model in hardware using an integrated circuit and memory and performs verification operations on a cell area of the memory model. Other inventive concepts and improvements in other technical issues are not limited to those described above, and improvements in other technical issues may be inferred from the following embodiments.

Additional aspects will be set forth in part in the description which follows and, in part, will be apparent from the description, or may be learned by practice of the presented embodiments of the disclosure.

According to some example embodiments, a verification system for verifying a cell area of a flash memory model includes a memory including a memory area, wherein, in order to verify the cell area, the cell area is modeled as the memory area, the verification system further including an integrated circuit configured to perform a verification operation on the memory based on a verification signal for the flash memory model, wherein the integrated circuit includes a memory control logic configured to map the cell area to the memory area based on the verification signal and to perform a memory operation corresponding to the verification signal to read verification data for the verification operation from the memory.

Alternatively or additionally according to various example embodiments, an operating method of a field programmable gate array (FPGA) for verifying a cell area of a flash memory model includes generating a verification signal for the flash memory model, generating, based on the verification signal, a memory control signal associated with a memory operation on a memory simulating the cell area, transmitting the memory control signal to the memory, receiving verification data associated with a verification operation from the memory, based on the memory control signal, and performing the verification operation on the cell area by comparing the verification data to reference data corresponding to the verification signal.

Alternatively or additionally according to various example embodiments, an integrated circuit for verifying a cell area of a flash memory model includes a verification logic configured to verify the cell area of the flash memory modeled as memory, wherein the verification logic is configured to generate a verification signal for the flash memory model and to perform a verification operation on the cell area based on reference data read from the memory, a peripheral logic configured to generate, based on the verification signal, a logic control signal for controlling the integrated circuit, a decoder logic configured to generate, based on the logic control signal, a first selection control signal for controlling word lines of the flash memory model, a buffer logic configured to generate, based on the logic control signal, a second selection control signal for controlling bit lines of the flash memory model, and a memory control logic configured to transmit a memory control signal to the memory, based on the first selection control signal and the second selection control signal, so that the cell area is configured to be mapped to a memory area of the memory, and a memory operation is configured to be performed on the memory to read verification data for the verification operation from the memory.

### BRIEF DESCRIPTION OF THE DRAWINGS

The above and other aspects, features, and advantages of certain example embodiments will be more apparent from the following description taken in conjunction with the accompanying drawings, in which:

FIG. 1 is a flowchart illustrating a flash memory design process according to various example embodiments;

FIG. 2 is a block diagram illustrating a verification system according to various example embodiments;

FIG. 3 is a diagram showing a flash memory model according to various example embodiments;

FIG. 4 is a block diagram illustrating an integrated circuit according to various example embodiments;

FIG. 5 is a diagram illustrating a verification logic according to various example embodiments;

FIG. 6 is a diagram illustrating operations of a memory control logic and memory according to various example embodiments;

FIG. 7 is a diagram illustrating a connection between an integrated circuit and memory according to various example embodiments;

FIG. 8 is a diagram illustrating a connection between an integrated circuit and memory according to various example embodiments;

FIG. 9 is a diagram illustrating an operation of verification logic according to various example embodiments; and

FIG. 10 is a flowchart illustrating a method of verifying an integrated circuit, according to various example embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The terms used in embodiments are selected from commonly used terms as much as possible while considering the functions in the examples. However, these terms may vary depending on the intentions of those skilled in the art, precedents, the emergence of new technologies, etc. Also, terms may be arbitrarily selected in certain cases. In this case, their meanings will be described in detail in the description of the relevant embodiment. Therefore, the terms used in the embodiments should be defined based on the meaning of the terms and the overall descriptions of the embodiments, rather than simply the names of the terms.

In the descriptions of embodiments, when it is described that a part is connected to another part, this includes not only a case where the part and another part are directly connected to each other, but also a case where the part and another part are electrically connected to each other with an intervening part therebetween. In addition, when it is described that a part includes a certain component, this indicates that the part may further include other components, rather than excluding other components, unless specifically stated to the contrary.

The terms “comprise” or “include” used in embodiments should not necessarily be interpreted as including all of the components or operations described in the specification. Instead, these terms should be interpreted as excluding some components or operations or including additional components or operations.

The description of the following embodiments should not be construed as limiting the scope of the rights, and features that can be easily inferred by a person skilled in the art should be construed as falling within the scope of the rights of the embodiments. Hereinafter, embodiments are described in detail with reference to the accompanying drawings. The same reference numerals are given to the same elements in the drawings, and repeated descriptions thereof are omitted.

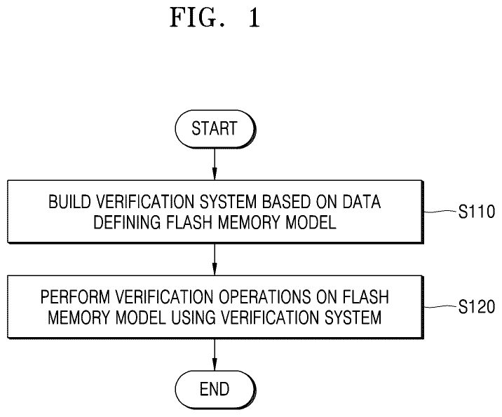

FIG. 1 is a flowchart illustrating a flash memory design process according to various example embodiments. Specifically, FIG. 1 shows at least a portion of a verification operation during the process of designing the flash memory. Although FIG. 1 illustrates a process of flash memory design, examples are not necessarily limited to flash memory design processes, and in some examples may be applied to other semiconductor design processes such as other memory design processes

The process of designing the flash memory may be generally divided into front-end design and back-end design. The front-end design includes a process of designing a logical operation performed by flash memory and may be referred to as logic design and/or as digital design. The back-end design includes a process conducted after the front-end design. In the back-end design, layout design may be performed using computer-aided design (CAD) programs. In the back-end design, the layout to be drawn on a substrate such as a wafer and/or the layout of a printed circuit board (PCB) may be designed. After the design process of the flash memory is performed, a manufacturing or fabrication process of the flash memory may be performed subsequently.

The front-end design process may include generating hardware description language (HDL) code. The flash memory to be manufactured may be expressed as HDL code through HDL coding. The HDL code includes code for describing a circuit to be manufactured in functional units using a hardware language, and the HDL coding may also be referred to as register-transfer level (RTL) coding. The HDL code according to various examples may be formed by languages, such as Verilog and/or very high-speed integrated circuit hardware description language (VHDL).

The front-end design process may include a synthesis operation. The synthesis operation may be performed after the HDL code is generated. During the synthesis operation, circuits for the flash memory may be synthesized to generate synthesis data. During the synthesis operation, a synthesis process may be performed to connect logical structures to each other on the basis of the HDL code. For example, the synthesis data may include a gate level netlist. Gates included in the gate level netlist may include various logical gates such as but not limited to AND gates, OR gates, NAND gates, multiplexers, etc.

The front-end design process may include a verification operation. The verification operation may be performed after the synthesis operation. However, example embodiments are not necessarily limited thereto, and the verification operation may be performed before, concurrently, or iteratively with the synthesis operation. The verification operation may include a process of verifying whether the flash memory circuit to be manufactured operates normally. According to the disclosure, the flash memory to be manufactured may be referred to as a flash memory model.

During the verification operation, verification of the flash memory model may be performed by simulation of the operation of the flash memory model on the basis of synthesis data of the flash memory model. During the simulation, the operation functions and/or operation characteristics of a design object (e.g., the flash memory model) may be simulated and predicted before the design object is formed into a physical object. In software simulation, design objects, such as a design target and a manufacturing target, are modeled at an appropriate abstraction level by a modeling process, and the simulation is performed thereon using a computer and/or a processor (e.g., central processing unit (CPU)). Also, the operation functions and operation characteristics of the design object may be formed in the computer in a simulation manner.

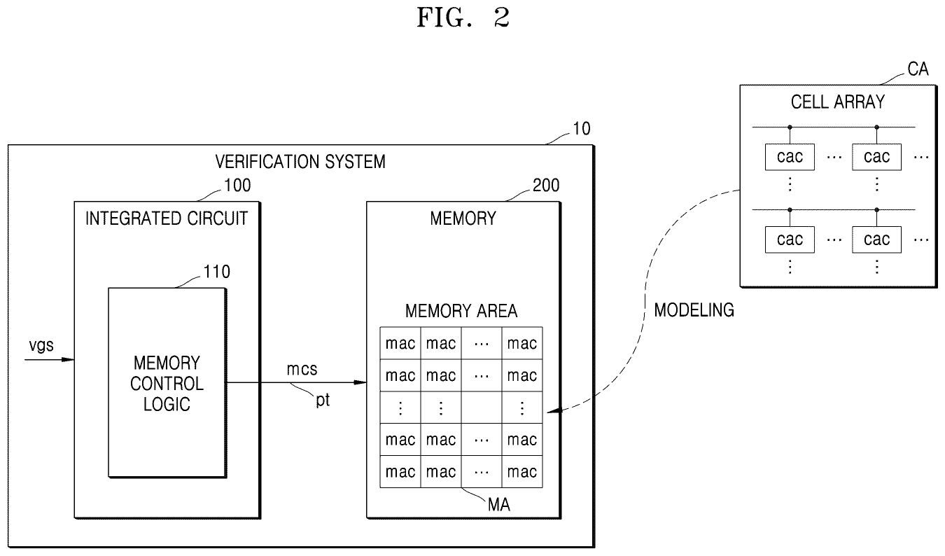

As the capacities and functions of the flash memory model increase, the amount of computation in the verification operation may increase. Alternatively or additionally, in the case of the software simulation, the verification speed is relatively low, and thus, the verification time may increase. Therefore, a verification system on hardware may be required or desirable. During the verification operation, the flash memory model may be verified using a verification system (e.g., a verification system 10 of FIG. 2). FIG. 1 at least partially illustrates the verification operation described above.

Referring to FIG. 1, the verification operation may include an operation S110 and an operation S120. In the operation S110, a verification system may be constituted on the basis of data defining a flash memory model. The data defining the flash memory model may include netlist information that forms functions of cell areas and peripheral circuits of the flash memory model.

In various example embodiments, the verification system may include an integrated circuit, and a flash memory model may be formed in the integrated circuit on the basis of the data defining the flash memory model. For example, the integrated circuit may include a field programmable gate array (FPGA). The memory-driving peripheral circuits and cell areas of the flash memory model may be provided as an FPGA and as memory connected to the FPGA. For example, the memory-driving peripheral circuits of the flash memory model may be modeled as logics or logic circuits of the FPGA, and the cell area may be modeled as the logic of the FPGA and the memory connected to the FPGA. Hereinafter, modeling of a flash memory model is described as an example. However, example embodiments are not necessarily limited thereto, and various models such as various memory models may be modeled. For example, the memory model to be modeled may include volatile memory, such as static random-access memory (SRAM) and/or dynamic random-access memory (DRAM), and/or non-volatile memory, such as one or more of flash memory, phase-change random-access memory (PRAM), and resistive random-access memory (RRAM). For example, the peripheral circuit of the memory model to be modeled may be modeled as logics of the FPGA, and the cell area may be modeled as the logic of the FPGA and the memory connected to the FPGA.

Since netlist information about the flash memory model may not be synthesized, the netlist information may be difficult to load onto the FPGA. Therefore, the netlist information about the flash memory model may be converted to enable RTL synthesis and then loaded onto the FPGA. For example, implementation on hardware may be possible. It is possible to construct a verification system that may model the flash memory model in hardware and perform verification operations thereon.

In the operation S120, the verification operation on the flash memory model may be performed using the verification system. For example, the verification operation on cell areas of the flash memory model may be performed using the verification system. The verification system is described in detail below with reference to FIG. 2. The verification system may shorten the verification time by performing simulation on the flash memory model in hardware.

FIG. 2 is a block diagram illustrating a verification system 10 according to various example embodiments. Descriptions already given above are omitted.

Referring to FIG. 2, the verification system 10 may include an integrated circuit 100 and memory 200. The verification system 10 may verify a cell area CA of the flash memory model. For example, the verification system 10 may verify whether the cell area CA of the flash memory model is operating normally. For example, in some cases the verification system 10 may distinguish between not operating, operating normally at high speed, and operating normally at low speed. In various example embodiments, the integrated circuit 100 and the memory 200 may be provided as a single chip, but example embodiments are not necessarily limited thereto.

The integrated circuit 100 may perform a verification operation on the memory 200. The cell area CA of the flash memory model may be modeled as memory 200. The memory 200 may simulate the cell area CA. The verification operations may include a write operation such as one or more of a program operation or an erase operation including writing reference data into the memory 200 simulating the cell area CA, a read operation of reading data, which has been written into the memory 200, from the memory 200 as verification data, and a comparison operation of comparing the reference data to the verification data. The integrated circuit 100 may perform at least some of the verification operations.

The integrated circuit 100 may perform the verification operation on the basis of a verification signal vgs. In various example embodiments, the verification signal vgs may be generated from an internal logic of the integrated circuit 100. However, example embodiments are not necessarily limited thereto, and the verification signal vgs may be received from outside the integrated circuit 100 to the integrated circuit 100. In various example embodiments, the integrated circuit 100 may include an FPGA, but example embodiments are s not necessarily limited thereto. Hereinafter, the description is made assuming that the integrated circuit 100 includes an FPGA.

The verification signal vgs is or includes a signal for the flash memory model and may include a verification operation command, a flash address, and a reference data. In some cases, the verification signal vgs may be a digital signal and/or an analog signal; example embodiments are not limited thereto. The verification operation command may represent a memory operation command for a cell area CA of the flash memory model that is simulated by a memory area MA of the memory 200. The memory operation commands may include write operation commands, program/erase commands, read operation commands, etc. The flash address may represent the address of a cell area CA on which the memory operation is to be performed. The reference data may represent data that is to be written on the cell area CA to perform the verification operation.

The integrated circuit 100 may include logics or logic circuits that perform functions of the memory-driving peripheral circuit of the flash memory model and at least some functions of the cell area. The integrated circuit 100 may include a memory control logic 110. The memory control logic 110 may control all operations of the memory 200. The memory control logic 110 may perform, on the memory 200, a memory operation corresponding to the verification signal vgs on the basis of the verification signal vgs. The memory control logic 110 may generate a memory control signal mcs to perform a memory operation corresponding to the verification signal vgs. For example, a memory control signal mcs may include signals, reference data, and the like, which control the memory 200 to perform the memory operation corresponding to the verification signal vgs.

The memory control logic 110 may transmit the memory control signal mcs to the memory 200 so that the memory operation is performed on the memory 200 on the basis of the verification signal vgs. The memory 200 may perform the memory operation corresponding to the verification signal vgs on the basis of the memory control signal mcs. In various example embodiments, the memory control logic 110 may transmit the memory control signal mcs via a port pt connected to the memory 200. For example, the memory control logic 110 may be connected to the memory 200 via a plurality of ports pt and transmit the memory control signal mcs to the memory 200 by using all of the plurality of ports pt.

The memory control logic 110 may perform, on the memory 200, the memory operation corresponding to the verification signal vgs on the basis of the verification signal vgs. The memory operations may include write operations and/or read operations. The memory control logic 110 may correspond or map the cell area CA to the memory area MA so that the cell area CA of the flash memory model is modeled as the memory area MA of the memory 200. In some cases, the correspondence may be one-to-one; example embodiments are not limited thereto. The memory control logic 110 may map cells cac of the cell area CA to a specific memory area of the memory area MA. For example, the memory control logic 110 may map the cells cac of the cell area CA to memory cells mac of the memory area MA on the basis of the mapping information for mapping the cell area CA to the memory area MA.

As described above, the cell area CA may in some cases correspond to an area of a flash memory that may be manufactured or fabricated, as the area to be modeled. The memory area MA may in some cases be a physical area in a physical device such as a volatile memory. Example embodiments are not limited thereto.

The memory control logic 110 may perform the memory operation on a target memory area corresponding to the verification signal vgs. The target memory area may represent a memory area, corresponding to the verification signal vgs, within the memory area MA. For example, the verification signal vgs may include a flash address representing a target cell area, on which the verification operation is to be performed, in the cell area CA of the flash memory model. The target memory area may include a memory area mapped to the target cell area. The verification signal vgs represents a verification operation for the flash memory model. However, since the memory control logic 110 maps the memory area MA to the cell area CA, the memory operation of the flash memory may be simulated using the memory 200 modeled as the flash memory model, even though an actual flash memory is not used.

The memory control logic 110 may perform the memory operation on the target memory area on the basis of the verification signal vgs and may read the verification data for the verification operation from the memory 200. For example, the memory control logic 110 may perform the memory operation of writing the reference data of the verification signal vgs to the target memory area and reading the data, written to the target memory area, as the verification data.

The integrated circuit 100 may verify the operation of the cell area CA of the flash memory model on the basis of the reference data and the verification data. For example, the integrated circuit 100 may compare the reference data to the verification data and may determine or verify the operation of the cell area CA on the basis of the comparison result. However, example embodiments are not necessarily limited thereto, and the operation of verifying the cell area CA on the basis of the reference data and verification data may be performed outside the integrated circuit 100.

The memory 200 may include the memory area MA, and the memory area MA may include the memory cells mac. For example, the memory 200 may include embedded memory. In various example embodiments, the memory 200 may include high bandwidth memory (HBM). The HBM may include a stacked memory in which a plurality of DRAM chips or dies are stacked to increase the capacity and speed of the memory 200. Hereinafter, the description is made assuming that the memory 200 of the verification system 10 includes the HBM.

In order to verify the cell area CA of the flash memory model, the cell area CA may be modeled as the memory area MA. The memory cells mac of the memory area MA may correspond to the cells cac of the cell area CA. The cell area CA may be modeled as the memory area MA by mapping the memory cells mac of the memory area MA and the cells cac of the cell area CA to each other. For example, a cell area CA of a NAND flash memory may be modeled as the memory area MA of the HBM.

The memory 200 may be connected to the integrated circuit 100. The memory 200 may be connected to the memory control logic 110. The memory 200 may receive the memory control signal mcs from the memory control logic 110. The memory 200 may be connected to the memory control logic 110 via one or more of the ports pt. The memory 200 may receive the memory control signal mcs via the port pt. The memory 200 may perform the memory operation on the basis of the memory control signal mcs. For example, the memory 200 may write the reference data into the target memory area on the basis of the memory control signal mcs and read the data, written into the target memory area, as verification data.

The cell area CA may be modeled as the memory area MA of the memory 200, and the functions of the memory-driving peripheral circuit of the flash memory model and the functions for modeling the cell area CA as the memory area (MA) are implemented as the logics of the integrated circuit 100. In some cases, for example when each cell cac is a single level cell, each cell cac included in the cell array CA may be mapped, e.g. virtually mapped, to one memory cell mac included in the memory 200. In some cases, e.g., when the cells cac included in the cell array CA are multilevel cells, each cell cac included in the cell array CA may be mapped, e.g. virtually mapped, to one memory cell mac included in the memory 200. Accordingly, the verification system 10 may be implemented on hardware. The verification system 10 implemented in hardware using the FPGA and HBM memory performs the verification operations on the cell area CA of the flash memory model. Accordingly, the verification speed may be increased and the verification time may be reduced, compared to the case where the cell area CA of the flash memory model is implemented in software and then verified.

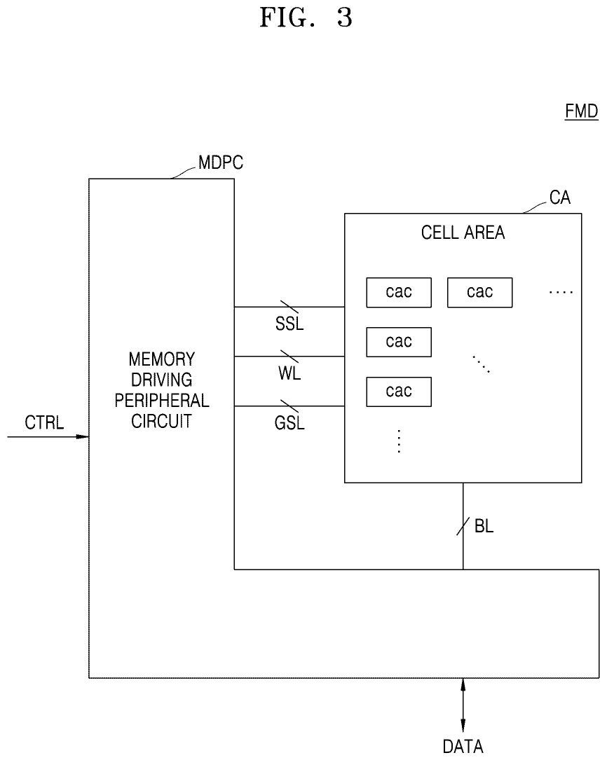

FIG. 3 is a diagram showing a flash memory model according to various example embodiments. FIG. 3 illustrates a flash memory model FMD and schematically illustrates a flash memory model to be implemented, e.g., of a flash memory to be manufactured or fabricated. The flash memory model FMD may also be referred to as a memory device.

Referring to FIG. 3, the flash memory model FMD may include a memory-driving peripheral circuit MDPC and a cell area CA. The memory-driving peripheral circuit MDPC may include components for controlling all operation of the flash memory model FMD. For example, the memory-driving peripheral circuit MDPC may include a control logic, a voltage generator, a row decoder, a page buffer, a redundancy checker, a row driver, and a sense amplifier.

The cell area CA may include a plurality of cells cac and be connected to word lines WL, string selection lines SSL, ground selection lines GSL, and a plurality of bit lines BL. Specifically, the cell area CA may be connected to the memory-driving peripheral circuit MDPC via the word lines WL, the string selection lines SSL, the ground selection lines GSL, and the bit lines BL. The cell area CA may also be referred to as a cell array.

The cell area CA may include a plurality of memory blocks. For example, each of the plurality of memory blocks may include the plurality of cells cac. Each of the plurality of memory blocks may have a three-dimensional structure (or a vertical structure). The plurality of memory blocks may be selected by the memory-driving peripheral circuit MDPC. For example, the memory-driving peripheral circuit MDPC may select a memory block corresponding to a block address among the plurality of memory blocks in the cell area CA.

Each of the cells cac in the cell area CA may store at least one bit. For example, the cell cac may include a single level cell (SLC) storing 1 bit of data. In another example, the cell cac may include a multi-level cell (MLC) storing 2 bits of data. However, example embodiments are not limited thereto. When an erase voltage is applied to the cell area CA, the plurality of cells cac are in an erase state. Also, when a write voltage or a program voltage is applied to the cell area CA, the plurality of cells cac may be in a write state. Here, each cell cac may have an erase state or at least one write state distinguished according to a threshold voltage. For example, the states of the memory cell may include an erase state and at least one write state, and the specific state of each memory cell may be an erase state or a specific write state.

The memory-driving peripheral circuit MDPC may generate various types of voltages to perform write operations, read operations, and erase operations for the cell area CA on the basis of a control signal CTRL. The memory-driving peripheral circuit MDPC may select a specific word line among the word lines WL in response to a row address on the basis of the control signal CTRL and may provide voltage to the selected word line. In some cases, the memory-driving peripheral circuit MDPC may select some of the string selection lines SSL or some of the ground selection lines GSL in response to the row address.

The memory-driving peripheral circuit MDPC may select a specific bit line among the bit lines BL in response to the column address on the basis of the control signal CTRL and may sense data DATA stored in the selected cell cac via the selected bit line. For example, the control signal CTRL may be provided from a memory controller that controls the memory-driving peripheral circuit MDPC. The memory-driving peripheral circuit MDPC may temporarily store data DATA read from the cell area CA or temporarily store data DATA to be stored in the cell area CA.

The flash memory model FMD may be modeled as an integrated circuit (e.g., the integrated circuit 100 of FIG. 1) and a memory (e.g., the memory 200 of FIG. 1). The memory-driving peripheral circuit MDPC of the flash memory model FMD may be implemented by logics, e.g., by logic circuits, that perform the function of the memory-driving peripheral circuit MDPC in the integrated circuit 100. The cell area CA may be implemented by logics of the integrated circuit 100 and the memory 200. The flash memory model FMD may be verified using a verification system (e.g., the verification system 10 of FIG. 1) in which the flash memory model FMD is implemented.

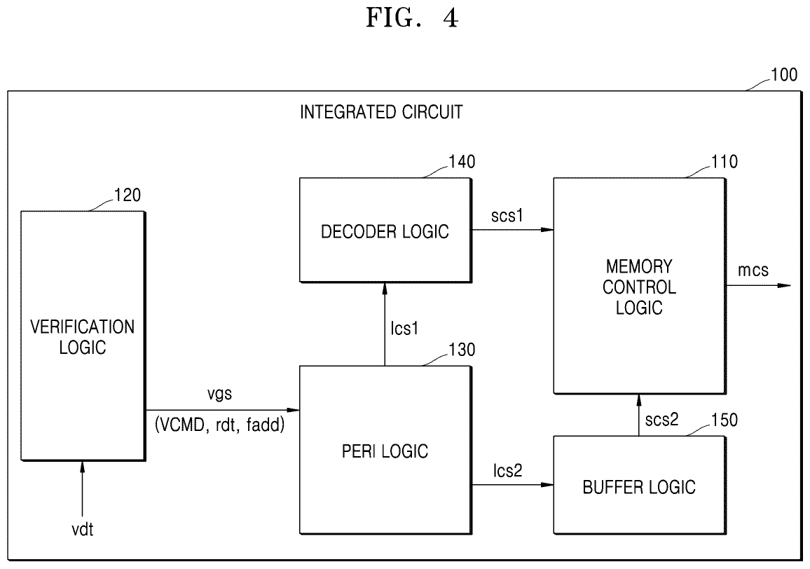

FIG. 4 is a block diagram illustrating an integrated circuit according to various example embodiments. An integrated circuit 100 may correspond to the integrated circuit 100 of FIG. 1. Repeated descriptions as those given above are omitted. Hereinafter, FIG. 2 is referred together.

Referring to FIG. 4, the integrated circuit 100 may include logics that perform the function of a memory-driving peripheral circuit (e.g., the memory-driving peripheral circuit MDPC of FIG. 3). The integrated circuit 100 may include a memory control logic 110, a verification logic 120, a peripheral logic 130, a decoder logic 140, and a buffer logic 150.

The verification logic 120 may perform the verification operation on the cell area of the flash memory model (e.g., the cell area CA of FIG. 2). The verification logic 120 may generate a verification signal vgs for performing a verification operation. A verification operation may be performed on the cell area CA of the flash memory model on the basis of the verification signal vgs, and the verification operation may be completed by comparing reference data rdt to verification data vdt.

The verification signal vgs may include a verification operation command VCMD, a flash address fadd, and the reference data rdt. The verification operation command VCMD may represent a memory operation command for the cell area CA of the flash memory model that is simulated by a memory area (e.g., the memory area MA of FIG. 2) of a memory (e.g., the memory 200 of FIG. 2). The memory operation commands may include write operation commands, read operation commands, etc. The flash address fadd may represent the address of a cell area CA on which the memory operation is to be performed. The reference data rdt may represent data that is to be written on the cell area CA to perform the verification operation. Since the cell area CA is modeled as the memory 200, the reference data rdt may be written to a target memory area corresponding to the cell area CA indicated by the flash address fadd. The verification signal vgs may be transmitted to the peripheral logic 130.

The verification logic 120 may perform the verification operation on a flash memory cell model on the basis of the verification data vdt and the reference data rdt. Based on the verification signal vgs, the reference data rdt may be written to the target memory area. In some cases, based on the verification signal vgs, the data written to the target memory area may be read as the verification data vdt from the memory 200. The verification logic 120 may compare the verification data vdt to the reference data rdt and verify whether the cell area CA operates normally on the basis of the comparison result obtained by comparing the verification data vdt to the reference data rdt. For example, the verification logic 120 may verify the cell area CA on the basis of whether the verification data vdt matches the reference data rdt.

The peripheral logic 130 may receive the verification signal vgs. The peripheral logic 130 may generate, based on the verification signal vgs, a logic control signal les for controlling the integrated circuit 100. The logic control signal les may include a first logic control signal lcs1 and a second logic control signal lcs2. Hereinafter, the first logic control signal lcs1 and the second logic control signal lcs2 are referred to as the logic control signal lcs. The peripheral logic 130 may output the logic control signal les to write data into the cell area CA or read data from the cell area CA. For example, the peripheral logic 130 may output the logic control signal lcs to write the reference data rdt into the cell area CA and read the verification data vdt from the cell area CA.

The peripheral logic 130 may generate a row address or word line address, and a column address or bit line address on the basis of the verification signal vgs. The peripheral logic 130 may generate a row address and a column address on the basis of the flash address fadd. The peripheral logic 130 may generate various types of voltages to perform write operations, program operations, read operations, and erase operations for the cell area CA on the basis of the verification signal vgs.

The peripheral logic 130 may transmit the first logic control signal lcs1 to the decoder logic 140. For example, the first logic control signal lcs1 may include the row address and the voltage to be applied to the word line of the cell area CA. The peripheral logic 130 may transmit the second logic control signal lcs2 to the buffer logic 150. For example, the second logic control signal lcs2 may include the column address and the voltage to be applied to the bit line of the cell area CA.

The decoder logic 140 may receive the first logic control signal lcs1. The decoder logic 140 may control word lines of the flash memory model. The decoder logic 140 may generate, based on the first logic control signal lcs1, a first selection control signal scs1 for controlling word lines of the flash memory model. The decoder logic 140 may select a specific word line among the word lines of the flash memory model in response to the row address and may output the first selection control signal scs1 that applies voltage. The decoder logic 140 may transmit the first selection control signal scs1 to the memory control logic 110.

The buffer logic 150 may receive the second logic control signal lcs2. The buffer logic 150 may control the bit lines of the flash memory model. The buffer logic 150 may generate, based on the second logic control signal lcs2, a second selection control signal scs2 for controlling the bit lines. The buffer logic 150 may select a specific bit line among the bit lines of the flash memory model in response to the column address. The buffer logic 150 may transmit the second selection control signal scs2 to the memory control logic 110. For example, the buffer logic 150 may be configured to temporarily store the reference data rdt to be stored in the cell area CA or to temporarily store the verification data vdt read from the cell area CA.

The memory control logic 110 may receive the first selection control signal scs1 and the second selection control signal scs2. Hereinafter, the first selection control signal scs1 and the second selection control signal scs2 are referred to as a selection control signal scs. The memory control logic 110 may generate, based on the selection control signal scs, a memory control signal mcs for performing the verification operation on the memory 200. The memory control logic 110 may generate the memory control signal mcs so that the verification operation on the cell area CA is mapped to the verification operation on the memory 200.

The memory control logic 110 may transmit the memory control signal mcs to the memory 200 to perform the memory operation on the memory 200. The memory 200 may perform the memory operation corresponding to the verification signal vgs on the basis of the memory control signal mcs. The memory control logic 110 may perform the verification operation on the memory 200 on the basis of the selection control signal scs. The memory control logic 110 may perform the memory operation belonging to the verification operation on the basis of the selection control signal scs.

When performing the verification operation on the memory 200, the memory control logic 110 may correspond or map the cell area CA of the flash memory model to the memory area MA so that the cell area CA of the flash memory model is modeled as the memory area MA of the memory 200 and may perform the memory operation thereon. The memory control logic 110 may perform the memory operation on the target memory area MA on the basis of the selection control signal scs and may read the verification data vdt for the verification operation from the memory 200. The memory control logic 110 may perform the memory operation on the target memory area on the basis of the memory control signal mcs and may read the verification data vdt for the verification operation from the memory 200.

For example, the memory control logic 110 may write the reference data rdt to the target memory area corresponding to the flash address fadd on the basis of the selection control signal scs. The memory control logic 110 may write the reference data rdt to the target memory area and then read the data, which has been written to the target memory area, as the verification data vdt after a first period of time has elapsed. The first period of time may represent a time preset in the verification system 10. The verification logic 120 may perform verification on the flash memory model by comparing the verification data vdt to the reference data rdt.

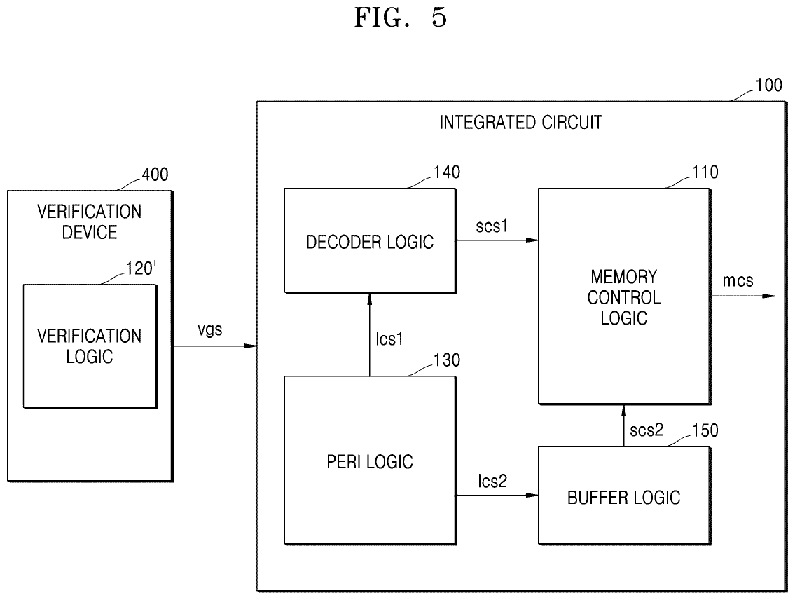

FIG. 5 is a diagram illustrating a verification logic according to various example embodiments. Compared to FIG. 4, a verification logic 120′ of FIG. 5 may be provided outside the integrated circuit 100. The verification logic 120′ of FIG. 5 may correspond to the verification logic 120 of FIG. 4. Repeated descriptions as those given above with reference to FIG. 4 are omitted.

Referring to FIG. 5, a verification system 10 may include a verification device 400 and an integrated circuit 100. The verification device 400 may include the verification logic 120′, and the integrated circuit 100 may include a memory control logic 110, a peripheral logic 130, a decoder logic 140, and a buffer logic 150.

The verification logic 120′ may be provided outside the integrated circuit 100. For example, the verification logic 120′ may be provided in the verification device 400 separate from the integrated circuit 100. The verification logic 120′ may generate a verification signal vgs for performing a verification operation. The verification signal vgs may be transmitted to the integrated circuit 100. The integrated circuit 100 may perform the verification operation on a cell area CA of a flash memory model on the basis of the verification signal vgs.

The verification logic 120′ may transmit reference data to the integrated circuit 100 for the verification operation. The verification logic 120′ may receive verification data from the integrated circuit 100 for the verification operation. The verification logic 120′ may perform the verification operation on the cell area CA of the flash memory model by comparing the verification data to reference data.

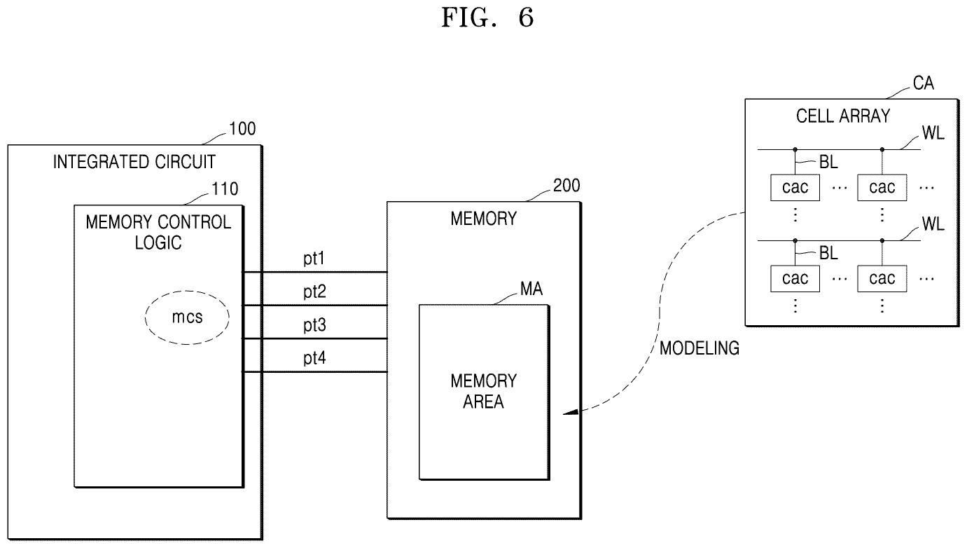

FIG. 6 is a diagram illustrating operations of a memory control logic 110 and memory 200 according to various example embodiments. Repeated descriptions as those given above are omitted.

Referring to FIG. 6, an integrated circuit 100 may be connected to the memory 200. The memory control logic 110 may transmit a memory control signal mcs to the memory 200. The memory 200 may be connected to the memory control logic 110 via a plurality of ports pt. In FIG. 6, a first port pt1 to a fourth port pt4 are referred to as a port pt. The memory control logic 110 may transmit the memory control signal mcs to the memory 200 using at least some of the plurality of ports pt. FIG. 6 illustrates that the memory control logic 110 is connected to the memory 200 via the first port pt1 to the fourth port pt4, that is, four ports pt. However, this is only an example, and the number of the plurality of ports is not necessarily limited thereto. For example, the number of ports pt may vary, such as 8, 16, or more than 16.

The memory control logic 110 may transmit the memory control signal mcs to the memory 200 on the basis of a bit line BL and the plurality of ports pt of the flash memory model that is simulated by the memory area MA of the memory 200. The cell area CA may be modeled as the memory area MA of the memory 200. The memory control logic 110 may correspond bit lines BL of the cell area CA to the plurality of ports pt. The memory control logic 110 may transmit the memory control signal mcs to the memory area MA via the plurality of ports pt corresponding to the bit line BL so that voltage is applied to the corresponding bit line BL, and may perform the verification operation on the target memory area corresponding to the target cell area on the basis of the memory control signal mcs. The target cell area may represent a cell area CA, on which the verification operation is to be performed, in the cell area CA. In some examples, the target memory area may represent a memory area MA, which corresponds to the target cell area, in the memory area MA.

In various example embodiments, the memory control logic 110 may evenly group the bit lines BL of the cell area CA to correspond to each of the plurality of ports pt. For example, if the cell area CA includes 16 bit lines BL, four bit lines BL may correspond to each port pt. The first bit line to the fourth bit line may correspond to the first port pt1, the fifth bit line to the eighth bit line may correspond to the second port pt2, the ninth bit line to the twelfth bit line may correspond to the third port pt3, and the thirteenth bit line to the sixteenth bit line may correspond to the fourth port pt4. However, this is only an example, and the number of ports pt and bit lines BL are not limited thereto. In some cases, the grouping may not be even.

The memory control logic 110 may evenly group the bit lines BL of the cell area CA to correspond to each of the plurality of ports pt, and may transmit the memory control signal mcs to the memory area MA by using all of the plurality of ports pt corresponding to the bit lines BL. The memory 200 is connected to the memory control logic 110 via the plurality of ports pt, and the memory control signal mcs is transmitted via all of the plurality of ports pt. Accordingly, the verification operations may operate in parallel, and the operation speed between the integrated circuit 100 and the memory 200 may increase or be improved upon.

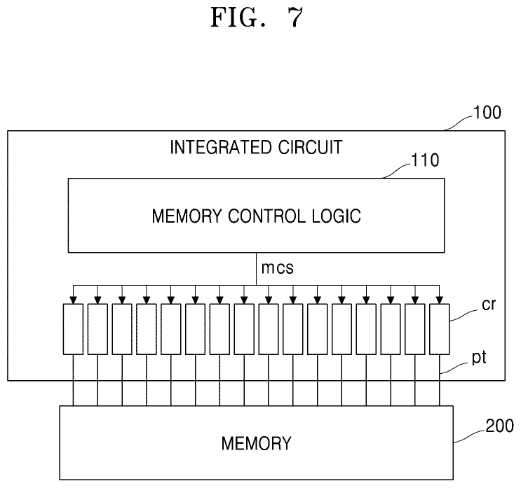

FIG. 7 is a diagram illustrating a connection between an integrated circuit 100 and memory 200 according to various example embodiments. The integrated circuit 100 may include different logics as shown in FIG. 4, but only some of the logics are illustrated in FIG. 7 for convenience. Repeated descriptions as those given above are omitted.

Referring to FIG. 7, the integrated circuit 100 may include a memory control logic 110 and a plurality of cores cr. The memory control logic 110 may generate a memory control signal mcs. For example, the memory control logic 110 may generate the memory control signal mcs on the basis of a selection control signal (e.g., the selection control signal scs of FIG. 4). The memory control signal mcs may be transmitted to the plurality of cores cr.

The core cr may transmit the memory control signal mcs to the memory 200. The core cr may access the memory 200. Cores cr may transmit the memory control signal mcs to ports pt so that the memory control signal mcs is transmitted to the memory 200 via the ports pt. The cores cr may respectively correspond to the plurality of ports pt. For example, the memory 200 may be connected to the integrated circuit 100 via 16 ports pt, and the 16 ports pt may respectively correspond to 16 cores cr. However, the number of ports pt and/or the number of cores cr are not necessarily limited thereto.

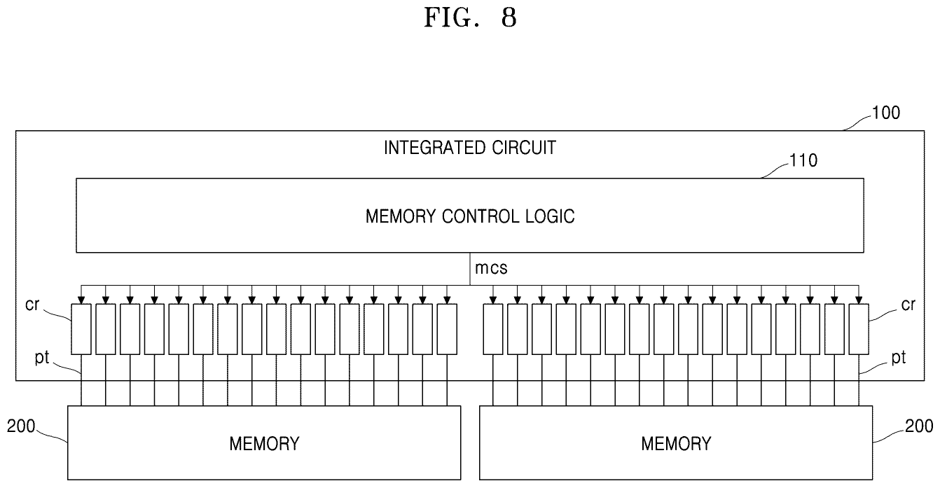

FIG. 8 is a diagram illustrating a connection between an integrated circuit 100 and memory 200 according to various example embodiments. Repeated descriptions as those given above with reference to FIG. 7 are omitted.

Referring to FIG. 8, the integrated circuit 100 may be connected to two memories 200. Two memory stacks including memory 200 may be connected to the integrated circuit 100. In various example embodiments, the memory 200 may include an HBM.

A memory control signal mcs may be transmitted to a plurality of cores cr, and the core cr may transmit the memory control signal mcs to the memory 200. The core cr may access the memory 200. The cores cr may transmit the memory control signal mcs to ports pt so that the memory control signal mcs is transmitted to the memory 200 via the ports pt. The cores cr may respectively correspond to the plurality of ports pt. For example, each memory 200 is connected to the integrated circuit 100 via 16 ports pt, and thus, the integrated circuit 100 may include 32 cores cr. The 16 ports pt connected to one memory 200 may respectively correspond to 16 cores cr, and the 16 ports pt connected to the other memory 200 may respectively correspond to the other 16 cores cr. However, the number of ports pt and cores cr is not necessarily limited thereto.

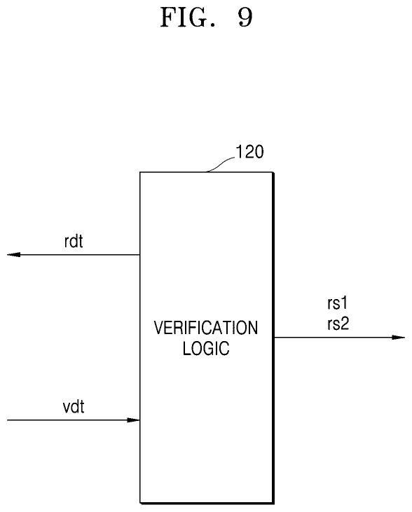

FIG. 9 is a diagram illustrating an operation of a verification logic 120 according to various example embodiments. Repeated descriptions as those given above are omitted.

The verification logic 120 may perform the verification operation on the cell area of the flash memory model (e.g., the cell area CA of FIG. 2). The verification logic 120 may transmit reference data rdt that is to be written on the cell area CA to perform the verification operation.

The verification logic 120 may receive verification data vdt through the verification operation. During the verification operation, the reference data rdt may be written to memory (e.g., the memory 200 of FIG. 2) that simulates the cell area CA, and the data written to the memory 200 may be read as the verification data vdt from the memory 200. For example, the reference data rdt is written to the target memory area, and after a first period of time has elapsed, the data written to the target memory area may be read as the verification data vdt.

The verification logic 120 may compare the verification data vdt to the reference data rdt and verify whether the cell area CA operates normally on the basis of the comparison result obtained by comparing the verification data vdt to the reference data rdt. The verification logic 120 may compare the verification data vdt to the reference data rdt and then output result signals rs1 and rs2.

In various example embodiments, the verification logic 120 may output the result signals rs1 and rs2 (or referred to as the first and second result signals rs1 and rs2) depending on whether the verification data vdt matches the reference data rdt. If the verification data vdt matches the reference data rdt, the data written to the target memory area matches the data read directly from the target memory area, so the verification logic 120 may determine that the target cell area simulated by the target memory area is operating normally. The verification logic 120 may output the first result signal rs1 when the verification data vdt matches the reference data rdt.

If the verification data vdt does not match the reference data rdt, the data written to the target memory area does not match the data read directly from the target memory area, so the verification logic 120 may determine that the target cell area simulated by the target memory area is operating abnormally. The verification logic 120 may output the second result signal rs2 when the verification data vdt does not match the reference data rdt. The second result signal rs2 may be a different from the first result signal rs1.

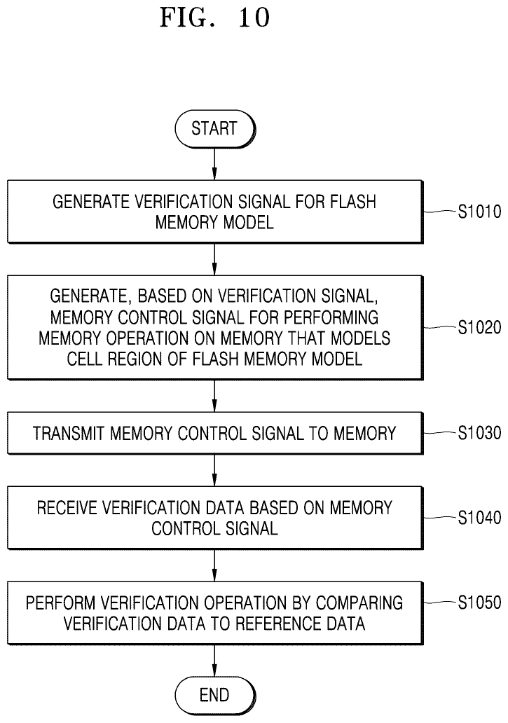

FIG. 10 is a flowchart illustrating a method of verifying an integrated circuit, according to various example embodiments. FIG. 10 shows a method of operating the integrated circuit 100 of FIG. 2. Repeated descriptions as those given above are omitted.

Referring to FIG. 10, the integrated circuit may perform a verification operation to verify a cell area of a flash memory model. The integrated circuit may perform the verification operation on the memory that simulates the cell area of the flash memory model. In operation S1010, the integrated circuit may generate a verification signal for the flash memory model.

The verification signal is a signal for the flash memory model and may include a verification operation command, a flash address, and a reference data. The verification operation command may represent a memory operation command for the cell area of the flash memory model. The memory operation commands may include write operation commands, read operation commands, etc. The flash address may represent the address of the cell area on which the memory operation is to be performed. The reference data may represent data that is to be written on the cell area to perform the verification operation.

In operation S1020, the integrated circuit may generate a memory control signal on the basis of the verification signal. The integrated circuit may generate the memory control signal for performing the memory operation corresponding to the verification signal. The integrated circuit may generate the memory control signal to perform the memory operation on the memory on the basis of the verification signal. The verification signal may control the verification operation of the flash memory model, and the integrated circuit may generate the memory control signal to correspond to the verification operation for the memory.

In operation S1030, the integrated circuit may transmit the memory control signal to the memory. The integrated circuit may transmit the memory control signal to the memory so that the memory operation is performed on the memory on the basis of the verification signal. The memory may perform the memory operation corresponding to the verification signal on the basis of the memory control signal. The integrated circuit may map the cell area to the memory area so that the cell area of the flash memory model is modeled as the memory area of the memory, and may perform the memory operation corresponding to the verification signal. The integrated circuit may perform the memory operation on the target memory area using the memory control signal and may read the verification data for the verification operation from the memory. The integrated circuit may perform the memory operation of writing the reference data into the target memory area and reading the data, which has been written in the target memory area, as the verification data. For example, the integrated circuit may write the reference data into the target memory area and read the verification data from the data written into the target memory area after a first period of time has elapsed. The first period of time may represent a time preset in the verification system.

In various example embodiments, the integrated circuit may transmit the memory control signal via a port connected to the memory. For example, the integrated circuit may be connected to the memory via a plurality of ports and may transmit the memory control signal to the memory by using all of the plurality of ports. The number of ports pt may vary, such as 8 and 16.

In operation S1040, the integrated circuit may receive the verification data on the basis of the memory control signal. The integrated circuit may read the data, written to the target memory area, as the verification data and receive the verification data from the memory.

In operation S1050, the integrated circuit may perform the verification operation on the flash memory model by comparing the verification data to the reference data. The integrated circuit 100 may compare the reference data to the verification data and verify the operation of the cell area on the basis of the comparison result. The integrated circuit may compare the verification data to the reference data and verify whether the cell area operates normally on the basis of the comparison result of comparing the verification data to the reference data. The integrated circuit may compare the verification data to the reference data and output the result signal.

In some example embodiments, after the verification operations of steps S1010 to S1050 illustrated in FIG. 10 are performed, a device such as a flash circuit may be fabricated based on the results of the verification operation.

In various example embodiments, the integrated circuit may output the result signal depending on whether the verification data matches the reference data. The integrated circuit may output a first result signal when the verification data matches the reference data. The integrated circuit may output a second result signal different from the first result signal when the verification data does not match the reference data.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A verification system for verifying a cell area of a flash memory model, the verification system comprising:
a memory comprising a memory area, wherein, in order to verify the cell area, the cell area is to be modeled as the memory area; and
an integrated circuit configured to perform a verification operation on the memory based on a verification signal for the flash memory model,
wherein the integrated circuit comprises a memory control logic configured to map the cell area to the memory area based on the verification signal and to perform a memory operation corresponding to the verification signal to read verification data associated with the verification operation from the memory.

2. The verification system of claim 1, wherein the integrated circuit comprises a field programmable gate array (FPGA).

3. The verification system of claim 1, wherein
the memory is connected to the integrated circuit via a plurality of ports, and
the memory control logic is further configured to
generate a memory control signal associated with performing, on the memory, the memory operation corresponding to the verification signal, and
transmit the memory control signal to the memory using at least some of the plurality of ports.

4. The verification system of claim 3, wherein the memory control logic is further configured to transmit the memory control signal to the memory based on the plurality of ports and on bit lines of the flash memory model.

5. The verification system of claim 4, wherein the memory control logic is further configured to evenly group the bit lines of the flash memory model so that the grouped bit lines respectively correspond to the plurality of ports, and to transmit the memory control signal to the memory via the plurality of ports so that a bit line voltage is applied to the bit lines.

6. The verification system of claim 1, wherein
the integrated circuit further comprises a verification logic configured to generate the verification signal, and
the verification logic is further configured to perform a verification operation on the cell area of the flash memory model by comparing the verification data read from the memory to reference data, wherein the reference data is in the integrated circuit and corresponds to the verification signal.

7. The verification system of claim 6, wherein
the verification signal comprises a verification operation command, a flash address, and the reference data for the flash memory model,
the memory control logic is further configured to, based on the verification signal, write the reference data on a target memory area, the reference data representing the memory area corresponding to the flash address, and read data written on the target memory area as the verification data after a first period of time elapses, and
the verification logic is further configured to perform verification on the cell area by comparing the verification data to the reference data.

8. The verification system of claim 7, wherein the verification logic is further configured to
output a first result signal in response to the verification data matching the reference data, and
output a second result signal different from the first result signal in response to the verification data not matching the reference data.

9. The verification system of claim 1, wherein the integrated circuit further comprises:
a peripheral logic configured to generate, based on the verification signal, a logic control signal associated with controlling the integrated circuit;
a decoder logic configured to generate, based on the logic control signal, a first selection control signal associated with controlling word lines of the flash memory model; and
a buffer logic configured to generate, based on the logic control signal, a second selection control signal associated with controlling bit lines of the flash memory model,
wherein the memory control logic is further configured to generate a memory control signal associated with performing the memory operation on the memory, based on the first selection control signal and the second selection control signal.

10. The verification system of claim 1, wherein the memory comprises high bandwidth memory.

11. An operating method of a field programmable gate array (FPGA) for verifying a cell area of a flash memory model, the operating method comprising:
generating a verification signal associated with the flash memory model;
generating, based on the verification signal, a memory control signal associated with performing a memory operation on a memory simulating the cell area;
transmitting the memory control signal to the memory;
receiving verification data for a verification operation from the memory, based on the memory control signal; and
performing the verification operation on the cell area by comparing the verification data to reference data corresponding to the verification signal.

12. The operating method of claim 11, wherein the transmitting of the memory control signal to the memory comprises transmitting the memory control signal to the memory via a plurality of ports connected to the memory.

13. The operating method of claim 12, wherein the transmitting of the memory control signal to the memory comprises grouping bit lines of the flash memory model so that the grouped bit lines respectively correspond to the plurality of ports, and transmitting the memory control signal to the memory via all of the plurality of ports so that bit line voltage is applied to the bit lines of the cell area.

14. The operating method of claim 11, wherein the memory control signal comprises a signal associated with performing the memory operation, wherein the memory operation comprises a write operation associated with writing the reference data on a target memory area of the memory and a read operation associated with reading data written on the target memory area as the verification data after a first period of time elapses from the write operation, and
wherein the target memory area is configured to be a memory area corresponding to the cell area, indicated by the verification signal, in the memory area of the memory.

15. The operating method of claim 11, wherein the performing of the verification operation comprises:
outputting a first result signal in response to the verification data matching the reference data; and
outputting a second result signal different from the first result signal in response to the verification data not matching the reference data.

16. The operating method of claim 11, wherein the generating of the memory control signal comprises:
generating, based on the verification signal, a logic control signal associated with controlling logics included in the FPGA;
generating, based on the logic control signal, a first selection control signal for controlling word lines of the flash memory model and a second selection control signal associated with controlling bit lines of the flash memory model; and
generating the memory control signal, based on the first selection control signal and the second selection control signal.

17. The operating method of claim 11, wherein the memory comprises high bandwidth memory.

18. An integrated circuit for verifying a cell area of a flash memory model, the integrated circuit comprising:
a verification logic configured to verify the cell area modeled as a memory, wherein the verification logic is further configured to generate a verification signal associated with the flash memory model and perform a verification operation on the cell area based on reference data read from the memory;
a peripheral logic configured to generate, based on the verification signal, a logic control signal associated with controlling the integrated circuit;
a decoder logic configured to generate, based on the logic control signal, a first selection control signal associated with controlling word lines of the flash memory model;
a buffer logic configured to generate, based on the logic control signal, a second selection control signal associated with controlling bit lines of the flash memory model; and
a memory control logic configured to transmit a memory control signal to the memory, based on the first selection control signal and the second selection control signal, so that the cell area is mapped to a memory area of the memory, and a memory operation is performed on the memory to read verification data associated with the verification operation from the memory.

19. The integrated circuit of claim 18, wherein the integrated circuit is connected to the memory via a plurality of ports, and
the memory control logic is further configured to
evenly group the bit lines of the flash memory model modeled using the memory area of the memory so that the grouped bit lines respectively correspond to the plurality of ports and
transmit the memory control signal to the memory via all of the plurality of ports.

20. The integrated circuit of claim 18, wherein the verification signal comprises a verification operation command, a flash address, and the reference data for the flash memory model,
the memory control logic is further configured to, based on the memory control signal, write the reference data on a memory area of the memory, corresponding to the flash address, and read data, written on the memory area, as the verification data after a first period of time elapses, and
the verification logic is further configured to perform the verification operation on the cell area of the flash memory model by comparing the verification data to the reference data.
